(19) United States
(12) Patent Application Publication
(10) Pub. No.: US 2025/0377793 A1
(43) Pub. Date: Dec. 11, 2025

(54) ACCESS PATTERN TRACKING

(71) Applicant: Micron Technology, Inc., Boise, ID (US)

(72) Inventors: Alessandro Orlando, Milano (IT); Massimiliano Turconi, Gorgonzola (IT); Danilo Caraccio, Milano (IT)

(21) Appl. No.: 19/222,888

(22) Filed: May 29, 2025

Related U.S. Application Data
(60) Provisional application No. 63/658,710, filed on Jun. 11, 2024.

(51) Int. Cl. G06F 3/06

(52) U.S. Cl. CPC G06F 3/0611; G06F 3/0653; G06F 3/0656; G06F 3/0659; G06F 3/0683

(57) ABSTRACT

Methods, systems, and devices for access pattern tracking are described. An access request associated with accessing first data stored in memory may be received. Based on receiving the access request, a hash value based on a page index indicated in the access request may be calculated. Based on the hash value, a counter associated with the hash value may be incremented. Based on incrementing the counter, an access pattern associated with access data in the memory may be indicated.

### CROSS REFERENCE

The present application for patent claims priority to U.S. Patent Application No. 63/658,710 by Orlando et al., entitled “ACCESS PATTERN TRACKING,” filed Jun. 11, 2024, which is assigned to the assignee hereof, and which is expressly incorporated by reference in its entirety herein.

### TECHNICAL FIELD

The following relates to one or more systems for memory, including access pattern tracking.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports access pattern tracking in accordance with examples as disclosed herein.

FIG. 2 shows an example of a subsystem that supports access pattern tracking in accordance with examples as disclosed herein.

FIG. 3 shows an example of a subsystem that supports access pattern tracking in accordance with examples as disclosed herein.

FIG. 4 shows an example of a subsystem that supports access pattern tracking in accordance with examples as disclosed herein.

FIG. 5 shows a block diagram of a memory system that supports access pattern tracking in accordance with examples as disclosed herein.

FIG. 6 shows a block diagram of a host system that supports access pattern tracking in accordance with examples as disclosed herein.

FIGS. 7 and 8 show flowcharts illustrating a method or methods that support access pattern tracking in accordance with examples as disclosed herein.

### DETAILED DESCRIPTION

A memory system utilized by a host system may include multiple tiers of memory, where the different tiers of memory may have different benefits (e.g., performance benefits, cost benefits, latency benefits, etc.). In some examples, “tier-aware” software implementations (which are primarily implemented at the host system) that are aware of the different tiers of memory have been found to improve the performance of a host system that uses a tiered memory system.

But primarily using software to monitor the access patterns for a set of memory tiers may reduce the performance of the software—e.g., by using resources allocated to the software that would otherwise be used to execute the services of the software. In some examples, the service in the software used to monitor the access patterns across memory tiers may be configured to reduce the effect on the performance of the software. For example, the access pattern service may be configured to use a lower sampling rate to monitor the access patterns across the memory tiers—e.g., the access pattern service may record every tenth, hundredth, thousandth, etc., memory access. However, using a lower sampling rate may reduce the accuracy of the access pattern tracking performed by the software. Thus, implementations (e.g., methods, systems, apparatuses, techniques, configurations, components) that support monitoring access patterns across memory tiers with a lower impact on software performance, with higher accuracy, or both, may be desired.

To support monitoring access patterns across memory tiers with a lower impact on software performance, with higher accuracy, or both, significant aspects of the access pattern monitoring may be performed at a memory system (e.g., rather than the access pattern monitoring being performed primarily at the host system).

In addition to applicability in memory systems as described herein, techniques for access pattern tracking may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by enabling access pattern tracking to be performed more accurately while reducing an impact of access pattern tracking on the host system, which may enable a host system to improve its performance by redistributing data among a memory system in accordance with the access pattern (without the offsetting negative impacts of implementing the access tracking primarily or entirely at the host system), among other benefits.

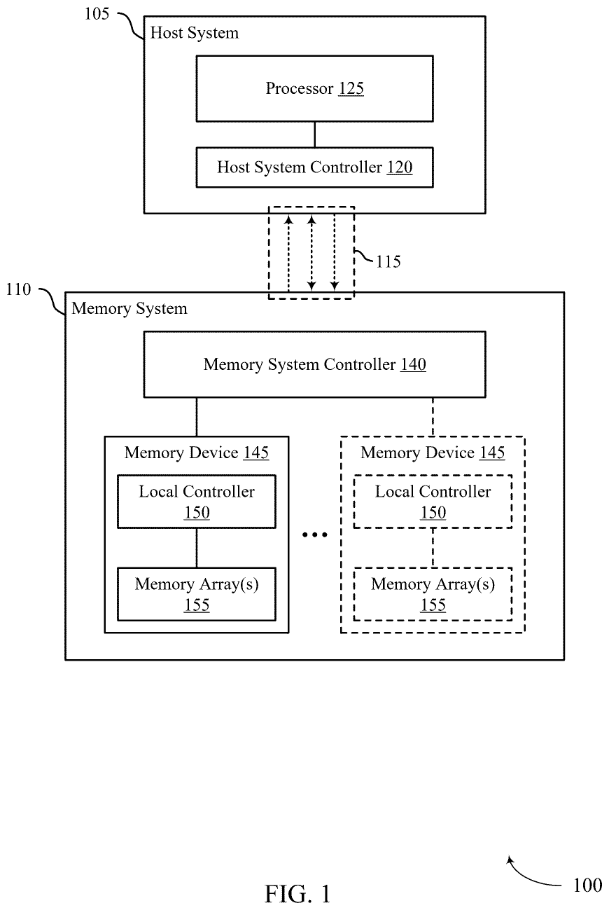

FIG. 1 illustrates an example of a system 100 that supports access pattern tracking in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

The host system 105 may include one or more components (e.g., circuitry, processing circuitry, one or more processing components) that use memory to execute processes, any one or more of which may be referred to as or be included in a processor 125. The processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. The processor 125 may be an example of a central processing unit (CPU), a graphics processing unit (GPU), a general-purpose GPU (GPGPU), or an SoC or a component thereof, among other examples.

The host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating the memory system 110, such as write commands, read commands, configuration signaling or other operational signaling. In some examples, the host system controller 120, or associated functions described herein, may be implemented by or be part of the processor 125. For example, a host system controller 120 may be hardware, instructions (e.g., software, firmware), or some combination thereof implemented by the processor 125 or other component of the host system 105. In various examples, a host system 105 or a host system controller 120 may be referred to as a host.

The memory system 110 provides physical memory locations (e.g., addresses) that may be used or referenced by the system 100. The memory system 110 may include a memory system controller 140 and one or more memory devices 145 (e.g., memory packages, memory dies, memory chips) operable to store data. The memory system 110 may be configurable for operations with different types of host systems 105, and may respond to commands from the host system 105 (e.g., from a host system controller 120). For example, the memory system 110 (e.g., a memory system controller 140) may receive a write command indicating that the memory system 110 is to store data received from the host system 105, or receive a read command indicating that the memory system 110 is to provide data stored in a memory device 145 to the host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of the memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with the host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 and one or more memory arrays 155. A memory array 155 may be a collection of memory cells (e.g., a two-dimensional array, a three-dimensional array), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

The memory system 110 may include multiple tiers of memory. In some examples, the performance of the different tiers of memory may be superior to one another in one or more aspects. For example, one tier of memory may be accessed faster than the other tiers of memory, another tier of memory may be more cost-effective than the other tiers of memory, an additional tier of memory may be accessed faster than the most cost-effective tier of memory and more cost-effective than the fastest tier of memory, and so on. In some examples, a tier of memory is based on its connection to the host system 105. For example, one tier of memory may have a faster link to the host system 105 than another tier of memory (e.g., that uses the same memory technology). Latch memory, phase change memory, resistive memory, capacitive memory, solid state memory, hard disk memory, magnetic tape memory, in-package memory, and compute express link memory are some examples of different tiers of memory that may be included in the memory system 110. In some examples, “host-managed” tiers of memory are managed by the host system 105. Host managed tiers of memory may include in-package memory, compute express link memory, dynamic random access memory, synchronous dynamic random access memory, high bandwidth memory, and the like.

In some examples, “tier-aware” software implementations that are aware of the different tiers of memory have been found to improve the performance of a system (such as the system 100). For example, tier-aware software has been found to be an effective option for improving the performance of operating systems, hypervisors, and container software—e.g., using application visible techniques (e.g., libmemtier, libmemkind). Tier-aware software may improve performance by distributing data among the tiers of memory (e.g., data that is frequently accessed may be moved to “higher” tiers of memory that are associated with faster access performance).

In some examples, tier-aware software implementations are primarily (e.g., fully) implemented at and managed by the host system 105. Accordingly, tier-aware software running at the host system 105 may keep track of the frequency at which particular data is accessed, a location of the particular within a set of memory tiers, and the like.

But primarily using software to monitor the access patterns for a set of memory tiers may reduce the performance of the software—e.g., by using resources allocated to the software that would otherwise be used to execute the services of the software. In some examples, the service in the software used to monitor the access patterns across memory tiers may be configured to reduce the effect on the performance of the software. For example, the access pattern service may be configured to use a lower sampling rate to monitor the access patterns across the memory tiers—e.g., the access pattern service may record every tenth, hundredth, thousandth, etc., memory access. However, using a lower sampling rate may reduce the accuracy of the access pattern tracking performed by the software. Thus, implementations (e.g., methods, systems, apparatuses, techniques, configurations, components) that support monitoring access patterns across memory tiers with a lower impact on software performance, with higher accuracy, or both, may be desired.

To support monitoring access patterns across memory tiers with a lower impact on software performance, with higher accuracy, or both, significant aspects of the access pattern monitoring may be performed at a memory system (e.g., rather than the access pattern monitoring being performed primarily at the host system).

In some examples, the host system 105 may send, to the memory system 110, multiple access requests within an interval, the access requests associated with access data stored in one or more pages of the memory system 110 (e.g., that are directly addressable by the host system 105), where the access requests may reference one or more page indices of the one or more pages. In some examples, the access requests are directed to one or more memory devices (e.g., the memory devices 145) at the memory system 110. Based on receiving an access request of the access requests, the memory system 110 may calculate a hash value based on a page index indicated in the access request. The memory system 110 may increment a counter associated with the calculated hash value. In some examples, incrementing the counter may include incrementing a value of an entry in a table (which may be referred to as a hash table), where the entry has an index corresponding to the calculated hash value. The memory system 110 may similarly calculate hash values and update counters based on receiving subsequent access requests of the multiple access requests.

Based on sending the plurality of access requests, the host system 105 may send a request to read a buffer at the memory system 110 that tracks a threshold quantity of page indices (e.g., up to X page indices, where X may be equal to a hundred, a thousand, etc.) that have been most recently accessed a threshold quantity of times (e.g., that have been accessed more than Y times in the interval, where Y may be equal to ten, twenty, etc.) in accordance with the access requests sent during the interval. In some examples, the memory system 110 stores the most recent, frequently accessed page indices in a first-in, first-out buffer. In response to the request to read the buffer, the memory system 110 may indicate, to the host system 105, an access pattern associated with accessing data in the memory system 110 in accordance with the access requests received in the interval—e.g., by indicating the contents of the FIFO buffer, the contents of the hash table, or both.

Based on the contents of the FIFO buffer, the contents of the hash table, or both, the host system 105 may determine an access pattern for the plurality of page indices. In some examples, the access pattern determined by the host system 105 includes analysis of access requests that were communicated prior to the interval. Based on determining the access pattern, the host system 105 may redistribute data across the memory system 110. For example, the host system 105 may transfer data at the most recent, frequently accessed page indices to a memory device in the memory system 110 that is associated with lower latency accesses.

By allocating aspects of the access pattern tracking to the memory system, access pattern tracking may be performed more accurately while reducing an impact of access pattern tracking on the performance of the host system (relative to performing a majority, or all, of the access pattern tracking at the host system). By storing the most recently, frequently access page indices at the memory system in a FIFO buffer, the memory system may provide, to the host system, immediate insights into a recent/current state of an access pattern without additional processing by the host system.

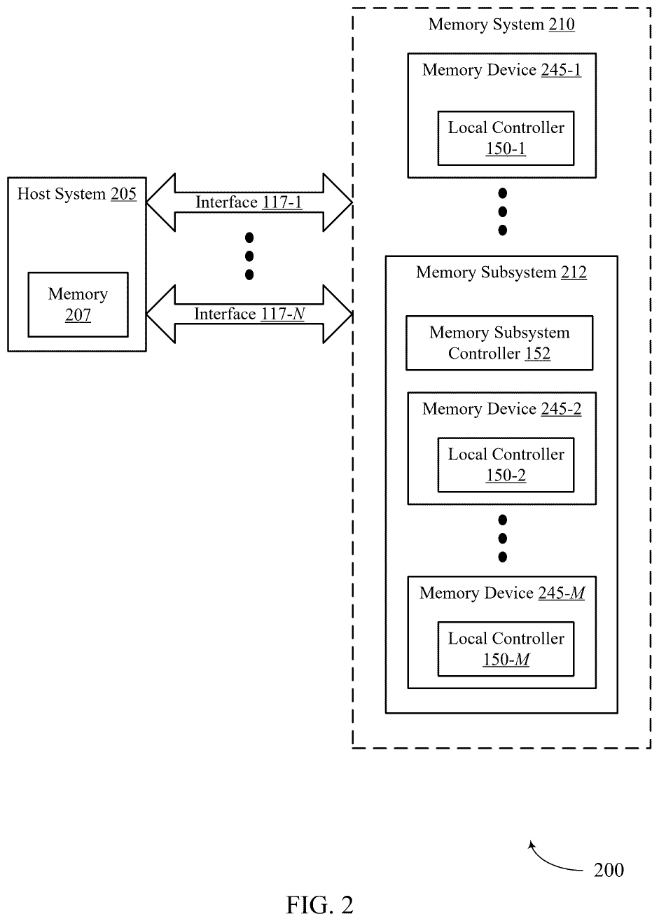

FIG. 2 shows an example of a subsystem that supports access pattern tracking in accordance with examples as disclosed herein.

The subsystem 200 may include the host system 205, which may be an example of a host system described herein (e.g., the host system 105 of FIG. 1), and the memory system 210, which may be an example of a memory system described herein (e.g., the memory system 110 of FIG. 1). The host system 205 and the memory system 210 may be connected by one or more interfaces (e.g., the first interface 117-1 and the Nth interface 117-N), which may each support one or more channels.

The host system 205 may include the memory 207, which may be referred to as an in-package memory. In some examples, the host system 205 may store data that is critical or frequently used (e.g., instructions) in the memory 207. One or more processors of the host system 205 may have direct access to the memory 207. In some examples, the memory 207 is host-addressable such that the physical addresses in access commands used to access data in the memory 207 correspond to physical addresses at the memory 207.

The interfaces may provide the host system 205 access to the memory system 210. In some examples, different interfaces may provide the host system 205 access to different memory devices. In some examples, the different interfaces may support different data transfer rates. For example, the first interface 117-1 may use a double data rate (DDR) protocol (e.g., DDR5) and may support a first level of data transfer rates. A second interface may use another double data rate protocol (DDR4) may support a second (e.g., lower) level of data transfer rates. A third interface may use a compute express link (CXL) protocol and may support a third (e.g., lower yet) level of data transfer rates. And the Nth interface 117-N may use a Peripheral Component Interconnect Express (PCIe) protocol and may support a fourth (e.g., lower still) level of data transfer rates.

The memory system 210 may include one or more memory devices (e.g., the first memory device 245-1) and one or more memory subsystems (e.g., the memory subsystem 212), which itself may include one or more memory devices. The different memory devices may use different memory technologies. For example, a first memory device may use a capacitive memory technology, a second memory device may use a phase change memory device, a third memory device may use a resistive memory device. In some examples, the different memory devices (using the same or different memory technologies) may support different frequencies of operation—e.g., a first memory device may support a first clock frequency (e.g., 4800 MHZ), a second memory device may support a second clock frequency (e.g., 3200 MHZ), and so on.

In some examples, the memory subsystem 212 may be configured to store data across the memory devices to provide protection against data failures. For example, the memory subsystem controller 152 may store a set of data across multiple of the memory devices, such that the stored data can be recovered even after a failure of one of the memory devices.

In some examples, the memory provided to the host system 205 by the memory system 210 is also host-addressable such that the physical addresses in access commands used to access data in the memory correspond to physical addresses at the memory system 210.

Based on the memory 207 located at the host system 205 and the different combinations of access interfaces (and their corresponding protocols) and memory devices (and their different memory technologies) provided to the host system 205 by the memory system 210, a tiered memory architecture may exist. For example, different memory devices may exhibit different performance based on their proximity to the host system 205, their supported memory protocol, and their underlying memory technology. Thus, a computing performance of the host system 205 may be based on where, within the tiered memory architecture, the host system 205 stores its data—e.g., a computing performance may be improved if the host system 205 stores the most frequently accessed data in the memory 207, the second most frequently accessed data in a memory device at the memory system associated with the fastest interface and the fastest memory technology, and so on. As described herein, in some examples, the host system 205, in coordination with one or more memory controllers at the memory system 210, tracks access patterns across the different tiers of memory to determine locations for data that are expected to improve performance.

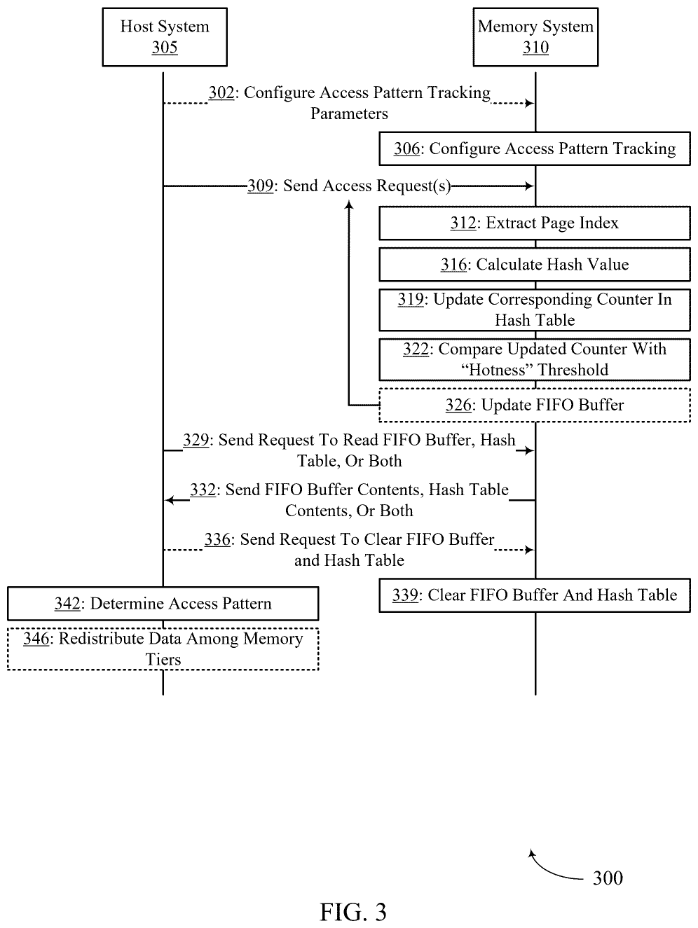

FIG. 3 shows an example of a subsystem that supports access pattern tracking in accordance with examples as disclosed herein.

The process flow 300 may be performed by the host system 305, which may be an example of a host system described herein (e.g., the host system 105 of FIG. 1, the host system 205 of FIG. 2) and the memory system 310 which may be an example of a memory system described herein (e.g., the memory system 110 of FIG. 1, the memory system 210 of FIG. 2). In some examples, the process flow 300 shows an example set of operations performed to support access pattern tracking. For example, the process flow 300 may include operations for tracking access patterns at a memory system, where the memory devices at the memory system may be included in a tiered memory system (which may include memory located on the host system and the memory system) used by the host system.

At 302, parameters for access pattern tracking at the memory system 310 may be configured (e.g., by the host system 305). The parameters that are configured may include a page range for which to perform the access pattern tracking, a page granularity used by the host system 305, a “counting” interval during which an access pattern tracking session is performed, an access pattern tracking mode, a sampling indicator indicating a frequency for the access pattern tracking, or any combination thereof.

In some examples, the duration for the counting interval is selected based on a false positive rate that is expected during the access pattern tracking procedure. As described herein, in some examples, the same hash value may be computed for different page indices. In such cases, a value of a counter having an index matching the hash value (and that is intended to track accesses for a single page index) may be artificially inflated. The incrementing of the counter using a different page index than intended may be referred to as a false positive. The duration for the counting interval may be selected to maintain a quantity of false positives below a threshold amount (e.g., a shorter counting interval may be associated with fewer false positives). In some examples, the counting interval is indicated as epochs (e.g., on a millisecond basis).

The access pattern tracking mode may be selected from one of multiple available modes: (1) a “read” access pattern tracking mode that performs access pattern tracking for only read requests; (2) a “write” access pattern tracking mode that performs access pattern tracking for only write requests; and (3) a “read/write” access pattern tracking mode that performs access pattern tracking for only read/write requests.

The sampling indicator may indicate how many/which access requests to analyze during a counting interval. For example, the sampling indicator may direct the access pattern tracking procedure to process every other access request that is received, every third access request that is received, etc. In some examples, the sampling indicator may direct the access pattern tracking procedure to process bursts of access requests. For example, the sampling indicator may direct the access tracking procedure to process every other set of (e.g., ten) access requests. In some examples, the sampling indicator may direct the access tracking procedure to process a set of (e.g., X, where X may be equal to five, ten, twenty, etc.) access requests, ignore a subsequent set of (e.g., Y, where Y may be equal to five, ten twenty, etc.) access requests, process a following set of (e.g., X) access request, and so on. In some examples, the sampling indicator may direct the access tracking procedure to perform pseudo random sampling.

Though the indicated sampling scheme may reduce the quantity of access requests processed by the memory system, the access pattern may still be tracked with more granularity than what is achievable by software that is implemented at the host system 305. Also, in some examples, a sampling scheme that reduces the quantity of access requests may actually improve accuracy of the tracked access pattern—e.g., by reducing a quantity of false positives that occur during an access tracking session. In some examples, the access pattern tracking procedure may be configured based on relationship between the counting interval and the sampling scheme (e.g., such that longer counting intervals may be used with more granular sampling schemes, and vice versa).

In some examples, the host system 305 employs an iterative process to configure the access pattern tracking parameters—e.g., by setting a first set of parameters, identifying the accuracy of the access pattern tracking procedure (e.g., based on identifying a quantity of false positives), and then modifying the first set of parameters (e.g., to reduce the quantity of false positives, to allow for the occurrence of more false positives, etc.).

At 306, the access pattern tracking procedure may be configured at the memory system 310—e.g., in accordance with the access pattern tracking parameters received from the host system 305.

As part of configuring the access tracking procedure, the memory system 310 may create (or (re)configure an already existing) hash table. In some examples, the hash table is created, or (re)configured, based on the page range and page granularity configured by the host system. For example, the quantity of entries in the hash table may be based on the quantity of pages indicated by the page range and page granularity. In some examples, the quantity of entries in the hash table may be less than or equal to the quantity of pages indicated by the page range and page granularity. Each entry of the hash table may be assigned an index that corresponds to a hash value that may be output by a hash function computed at the memory system. Each entry of the hash table may also be configured as a counter such that each time an entry of the hash table is accessed, a value of the entry may be incremented. In some examples, each entry of the hash table also includes a field for indicating whether a page index associated with the entry is currently stored in a FIFO buffer—e.g., to prevent the same page index from being stored in the FIFO buffer multiple times.

In some cases, multiple page indices within the same page range, and/or pages outside the page range, may map to the same entry in the hash table (which may cause false positives during the access tracking procedure).

In some examples, the memory system 310 configures a sampling scheme on its own (e.g., without receiving a sampling indicator value from the host system 305). For example, the memory system 310 may configure a sampling scheme that is configured to enable the memory system 310 to achieve a performance threshold. In some examples, the host system 305 may override a sampling scheme that is set and configured by the memory system 310.

In some examples, after the access pattern tracking procedure is configured, the memory system 310 may automatically begin monitoring access patterns. Additionally, or alternatively, after the access pattern tracking procedure is configured, the host system 305 may send a command to the memory system 310 to begin monitoring access patterns. In some examples, at a later time, the host system may similarly send a command to the memory system 310 to stop monitoring access patterns.

At 309, one or more access requests may be sent to the memory system 310 (e.g., by the host system 305). The access request(s) may include a command (e.g., a read command, a write command, etc.) and may indicate an address in the memory system 310 (e.g., by indicating a page index). In some examples, the memory system 310 may be host-addressable and the addresses indicated in the access request(s) may be host physical addresses.

At 312, a page index may be extracted (e.g., by the memory system 310) from an access request of the one or more access requests received from the host system 305. In some examples, the memory system 310 may extract a page index from a subset of multiple access requests received from the host system 305 (e.g., in accordance with a configured sampling scheme). In some examples, the memory system 310 may extract a page index from each access request received from the host system 305.

In some examples, the one or more access requests are directed to multiple memory devices within the memory system 310 and processed by respective controllers of the memory devices. In some examples, each controller may individually configure and perform access pattern tracking—in some cases, the host system 305 may individually configure access pattern tracking for each of the memory devices. In some examples, a memory subsystem includes a controller and multiple memory devices, where the controller may store data across the multiple memory devices in an interleaved fashion.

At 316, a hash value may be calculated (e.g., by the memory system 310, or a controller of a memory device of the memory system 310) for the extracted page index by applying the page index to a hash function. In some examples, prior to calculating the hash value, the extracted page index may be shifted (e.g., >>12), and the shifted page index may be entered into the hash function.

At 319, a corresponding counter may be updated (e.g., by the memory system) in the hash table. In some examples, the hash value may be compared against the index values for the entries of the hash table. Based on identifying an entry having an index matching the hash value, a value of a counter stored at that entry may be read and incremented.

At 322, the updated value of the counter at the updated entry may be compared (e.g., by the memory system 310) with a threshold value (which may be referred to as a “hotness” threshold).

At 326, a FIFO buffer may be updated (e.g., by the memory system 310) based on comparing the updated value of the counter with the threshold value. In some examples, the FIFO buffer may support fewer entries than (e.g., half of, a quarter of, a tenth of) the hash table.

If the updated value of the counter satisfies (e.g., is greater than or equal to) the threshold value, the extracted page index may be loaded into the FIFO buffer. In some examples, the value of the page index is temporarily stored while the hash value is calculated and the corresponding counter is updated and compared with the threshold value—e.g., because the index of the entry in the hash table may not itself indicate the value of the page index (as described herein, the index of the entry may correspond to multiple page indexes). Accordingly, if the updated value of the counter satisfies the threshold value, the stored page index may be loaded into the FIFO buffer. If the updated value of the counter does not satisfy (e.g., is less than) the threshold value, the contents of the FIFO buffer may be left unchanged.

In some examples, based on the updated value of the counter satisfying the threshold and loading the page index into the FIFO buffer, a flag for the entry including the counter may be set to indicate that a page index corresponding to the entry has been loaded into the FIFO buffer. In such cases, for subsequent updates to the counter, the memory system may refrain from loading the corresponding temporarily stored page index into the FIFO buffer—e.g., to avoid duplicate page indices from being stored in the FIFO buffer.

In some examples, the FIFO buffer may be full prior to loading the page index into the FIFO buffer. In such cases, prior to loading the FIFO buffer, a page index stored in a leading entry in the FIFO buffer (e.g., page index that has been stored in the FIFO buffer the longest) may be evicted from the FIFO buffer. And the other page indices in the FIFO buffer may be moved up in the FIFO buffer.

In some examples, the evicted page index may be applied to the hash function, and a flag for an entry having an index corresponding to the resulting hash value may be reset to indicate that a page index corresponding to the entry is not loaded in the FIFO buffer.

The operations described with reference to 309 to 326 may be repeated for multiple access requests received during a counting interval (e.g., each received access request received during the counting interval, a subset of the access requests received during the counting interval, etc.).

At 329, a request to read the FIFO buffer, the hash table, or both, may be sent to the memory system 310 (e.g., by the host system 305). In some examples, the host system 305 sends the request to read the FIFO buffer, the hash table, or both, at the end of a counting interval.

At 332, the contents of the FIFO buffer, the contents of the hash table, or both, may be sent to the host system 305 (e.g., by the memory system 310).

At 336, based on receiving (e.g., and successfully reading) the contents of the FIFO buffer, the contents of the hash table, or both, a request to clear the FIFO buffer and the hash table may be sent to the memory system 310 (e.g., by the host system 305).

At 339, the contents of the FIFO buffer and the contents of the hash table may be cleared (e.g., reset)—e.g., by the memory system 310 in response to the request from the host system 305 or automatically as a result of sending the contents to the host system 305. In some examples, the contents of the FIFO buffer and the contents of the hash table may be cleared automatically at an end of the counting interval—e.g., so the data structure does not saturate. After clearing the FIFO buffer and the hash table, the memory system 310 may initiate a second access pattern tracking session during a second counting interval (e.g., repeating the operations described with reference to 309 to 326.

At 342, an access pattern may be determined based on the received contents of the FIFO buffer, the hash table, or both. In some examples, the access pattern may be implemented by the host system 305 as a heat map. In some examples, the received contents may be used to update an existing access pattern (e.g., heat map) being maintained by the host system 305.

In some examples, to use the hash table to determine the access pattern, the host system 305 may use the same hash function as the memory system to determine which page indices correspond to which entries in the hash table. In some examples, entries in the hash table that correspond to multiple page indices may be ignored. In some examples, for entries in the hash table that correspond to multiple page indices, the host system 305 may determine which of the page indices most likely corresponds to the entries in the hash table (e.g., based on prior access patterns, etc.).

At 346, data in the memory system 310 may be redistributed among one or more memory tiers supported by the host system 305—e.g., based on the determined (e.g., updated) access pattern. In some examples, the host system 305 may identify data that is being accessed frequently (and, in some examples, recently) based on the determined access pattern. In some examples, the host system 305 may identify a location of the data in the tiers of the memory system 310 and move the identified data to a higher tier of memory. In some examples, the host system 305 may move first data that was recently accessed more than a threshold quantity of times to a highest tier of memory, second data that was recently accessed more than a second, lower threshold quantity of times to a second highest tier of memory, and so on. Additionally, or alternatively, the host system 305 may move first data that was recently accessed less than a threshold quantity of times to a lowest tier of memory, second data that was recently access less than a second, higher threshold quantity of times to a second lowest tier of memory, and so on.

Although primarily described in the context of a single controller, as described herein, the host system 305 may send access requests to multiple memory devices. In such cases, multiple controllers associated with the multiple memory device may similarly maintain hash tables and FIFO buffers and may communicate the corresponding contents to the host system 305. The host system 305 may use the data received from the multiple controllers to determine an access pattern across the tiers of the memory system 310.

Aspects of the process flow 300 may be implemented by a controller, among other components. Additionally, or alternatively, aspects of the process flow 300 may be implemented as instructions stored in memory (e.g., firmware stored in a memory coupled with a controller). For example, the instructions, when executed by a controller, may cause the controller to perform the operations of the process flow 300.

One or more of the operations described in the process flow 300 may be performed earlier or later, omitted, replaced, supplemented, or combined with another operation. Also, additional operations described herein may replace, supplement or be combined with one or more of the operations described in the process flow 300.

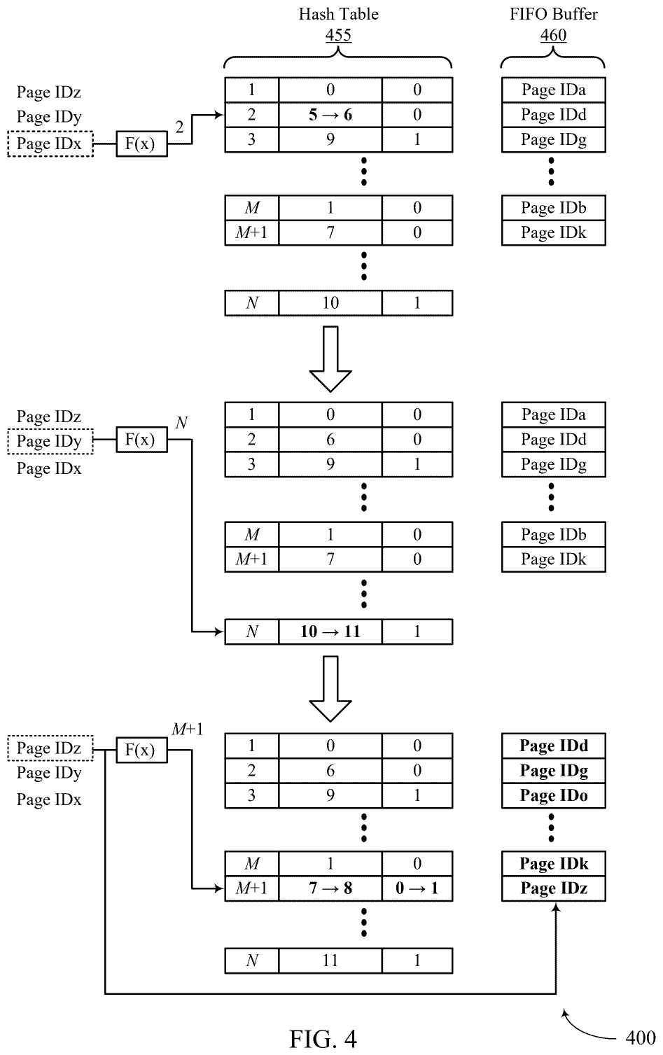

FIG. 4 shows an example of a subsystem that supports access pattern tracking in accordance with examples as disclosed herein.

The flow diagram 400 depicts an operation of a hash table (e.g., the hash table 455) and a FIFO buffer (e.g., the FIFO buffer 460) during an access pattern tracking procedure performed by a memory controller in a memory system (e.g., the memory system 110 of FIG. 1, the memory system 210 of FIG. 2, the memory system 310 of FIG. 3), as described herein. The hash table 455 may include a first field that is used to store an index value, a second field that is used to store a counter, and a third field which is used to store a FIFO buffer flag. In some examples, the hash table 455 omits a field for storing the index value, and the index value is implied by a position of an entry in the hash table 455.

In some examples, a first page index (Page IDx) may be received at the memory controller in an access request. The first page index may be extracted from the access request and inputted into a hash function. The hash function may output a hash value (e.g., 2). The memory controller may then identify the entry in the hash table 455 that has an index corresponding to the hash value. Based on identifying the entry, the memory controller may increment the value in the entry and determine whether the incremented value exceeds a “hotness” threshold value (e.g., 8). Based on determining the incremented value is below the threshold value, the memory controller may process a next page index.

The second page index (Page IDy) may be received at the memory controller in a second access request. The second page index may be extracted from the second access request and inputted into the hash function. The hash function may output a second hash value (e.g., N). The memory controller may then identify the entry in the hash table 455 that has an index corresponding to the hash value. Based on identifying the entry, the memory controller may increment the value in the entry and determine whether the incremented value exceeds the “hotness” threshold value. Based on determining the incremented value satisfies the hotness threshold, the memory controller may determine whether a page index has already been stored for the entry. Based on determining that a page index has already been stored for the entry (e.g., based on identifying the FIFO flag is set to one for the entry), the memory controller may process a next page index. In some examples, the page index may be moved to the front of the FIFO buffer 460 to prevent the page index from getting evicted.

The third page index (Page IDz) may be received at the memory controller in a third access request. The third page index may be extracted from the third access request and inputted into the hash function. The hash function may output a third hash value (e.g., M+1). The memory controller may then identify the entry in the hash table 455 that has an index corresponding to the hash value. Based on identifying the entry, the memory controller may increment the value in the entry and determine whether the incremented value is equal to the “hotness” threshold value. Based on determining the incremented value satisfies the hotness threshold, the memory controller may determine whether a page index has already been stored for the entry. Based on determining that a page index has not yet been stored for the entry (e.g., based on identifying the FIFO flag is set to zero for the entry), the memory controller may load the third page index into the FIFO buffer 460. Moreover, based on the FIFO buffer 460 being full, the memory controller may evict the page index from a top of the FIFO buffer 460 (e.g., the page index that has been in the FIFO buffer 460 for the longest duration), move each of the remaining entries up one position in the FIFO buffer 460, and load the third page index into a bottom of the FIFO buffer 460. In some examples, the FIFO buffer flag associated with the evicted page index may be cleared when the page index is evicted. In some examples, rather than evicting the page index from the top of the FIFO buffer 460, the memory controller may evict a page index from a random position in the FIFO buffer 460—in some examples, the random position may be selected from a set of positions located in a top portion (e.g., a top third or top half) of the FIFO buffer 460. Other techniques for evicting page indices from the FIFO buffer 460 may be used—e.g., the least recently used page index in the FIFO buffer 460 may be evicted, the least frequently used page index in the FIFO buffer 460 may be evicted, a second-chance algorithm may be used when determine which page index to evict, etc.

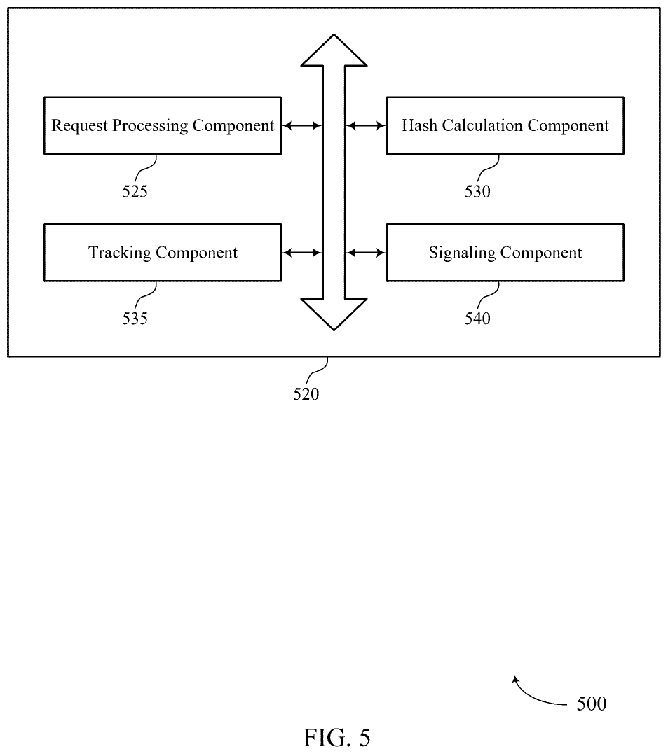

FIG. 5 shows a block diagram 500 of a memory system 520 that supports access pattern tracking in accordance with examples as disclosed herein. The memory system 520 may be an example of aspects of a memory system as described with reference to FIGS. 1 through 4. The memory system 520, or various components thereof, may be an example of means for performing various aspects of access pattern tracking as described herein. For example, the memory system 520 may include a request processing component 525, a hash calculation component 530, a tracking component 535, a signaling component 540, or any combination thereof. Each of these components, or components of subcomponents thereof (e.g., one or more processors, one or more memories), may communicate, directly or indirectly, with one another (e.g., via one or more buses).

The request processing component 525 may be configured as or otherwise support a means for receiving, from a host system, an access request associated with accessing first data stored in a memory of a plurality of memories of the memory system. The hash calculation component 530 may be configured as or otherwise support a means for calculating, at the memory based on receiving the access request, a hash value based on a page index indicated in the access request. The tracking component 535 may be configured as or otherwise support a means for incrementing, based on the hash value, a counter of a plurality of counters, the counter being associated with the hash value. The signaling component 540 may be configured as or otherwise support a means for indicating, based on incrementing the counter, an access pattern associated with accessing data in the memory to the host system.

In some examples, the tracking component 535 may be configured as or otherwise support a means for comparing, after incrementing the counter, a value of the counter with a threshold value.

In some examples, the tracking component 535 may be configured as or otherwise support a means for storing, based on a value of the counter exceeding a threshold value after incrementing the counter, the page index in a buffer.

In some examples, the tracking component 535 may be configured as or otherwise support a means for storing, based on storing the page index in the buffer, an indication that the page index associated with the counter is stored in the buffer.

In some examples, the tracking component 535 may be configured as or otherwise support a means for removing, based on storing the page index in the buffer, a second page index from the buffer based on the buffer being full, the second page index being stored in the buffer for a longest duration relative to other page indices stored in the buffer.

In some examples, the signaling component 540 may be configured as or otherwise support a means for receiving from the host system, after storing the page index in the buffer, a request to read the buffer, the plurality of counters, or both, where indicating the access pattern to the host system includes outputting, to the host system, contents of the buffer, values of the plurality of counters, or both, in response to the request to read the buffer, the plurality of counters, or both.

In some examples, the tracking component 535 may be configured as or otherwise support a means for clearing, based on outputting the contents of the buffer, the values of the plurality of counters, or both, to the host system, the buffer and the plurality of counters.

In some examples, the tracking component 535 may be configured as or otherwise support a means for receiving from the host system, prior to receiving the access request, one or more parameters associated with monitoring the access pattern, the one or more parameters including a page granularity, a page range, a counting interval, a threshold value, a tracking mode, or any combination thereof. In some examples, the tracking component 535 may be configured as or otherwise support a means for configuring data to be stored in the memory based on the page granularity, the plurality of counters based on the page range and the page granularity, a value for updating values of the plurality of counters based on the counting interval, a value to be compared with updated values of the plurality of counters based on the threshold value, a mode for tracking read accesses, write accesses, or both, based on the tracking mode, or any combination thereof.

In some examples, the tracking component 535 may be configured as or otherwise support a means for setting, prior to receiving the access request, a sampling rate associated with monitoring the access pattern. In some examples, the request processing component 525 may be configured as or otherwise support a means for receiving, based on setting the sampling rate, a plurality of access requests during a counting interval, the plurality of access requests including the access request. In some examples, the tracking component 535 may be configured as or otherwise support a means for processing, based on receiving the plurality of access requests, a subset of a plurality of page indices received in the plurality of access requests based on the sampling rate, where the hash value for the page index indicated in the access request is calculated based on the page index being included in the subset of the plurality of page indices.

In some examples, the tracking component 535 may be configured as or otherwise support a means for receiving, prior to receiving the access request, an indication of a page range for which the access pattern is to be monitored, where a quantity of the plurality of counters is based on the page range.

In some examples, the memory includes a plurality of memory devices coupled with a controller of the memory.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

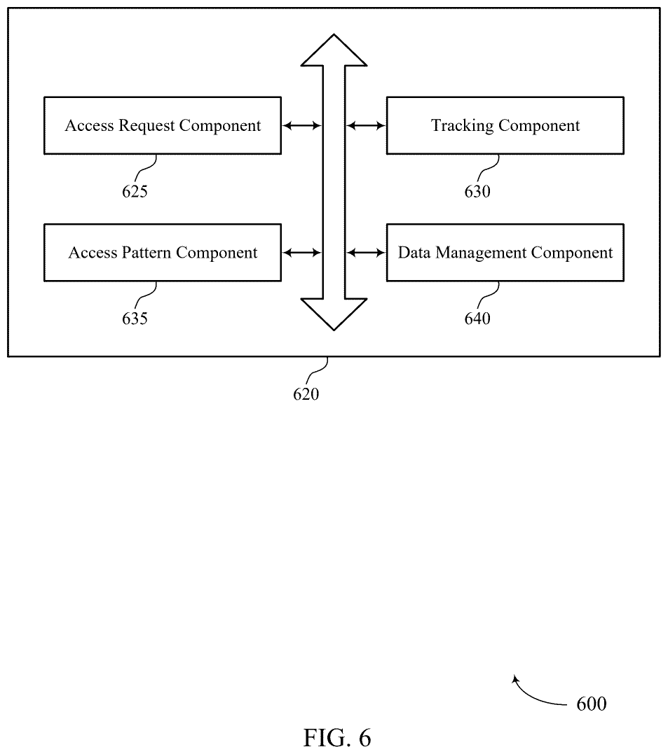

FIG. 6 shows a block diagram 600 of a host system 620 that supports access pattern tracking in accordance with examples as disclosed herein. The host system 620 may be an example of aspects of a host system as described with reference to FIGS. 1 through 4. The host system 620, or various components thereof, may be an example of means for performing various aspects of access pattern tracking as described herein. For example, the host system 620 may include an access request component 625, a tracking component 630, an access pattern component 635, a data management component 640, or any combination thereof. Each of these components, or components of subcomponents thereof (e.g., one or more processors, one or more memories), may communicate, directly or indirectly, with one another (e.g., via one or more buses).

The access request component 625 may be configured as or otherwise support a means for sending to a memory system including a plurality of memories, during an interval, a plurality of access requests associated with accessing data stored in one or more pages of one or more memories of the plurality of memories, where the plurality of access requests reference one or more page indices of a plurality of page indices, the one or more page indices corresponding to one or more pages. The tracking component 630 may be configured as or otherwise support a means for sending to the memory system, based on sending the plurality of access requests, a request to read a buffer at the memory system that tracks a threshold quantity of page indices of the plurality of page indices that have been most recently accessed a threshold quantity of times in accordance with the plurality of access requests during the interval. The access pattern component 635 may be configured as or otherwise support a means for determining, based on contents of the buffer, an access pattern for the plurality of page indices. The data management component 640 may be configured as or otherwise support a means for redistributing, based on the access pattern, data among the plurality of memories.

In some examples, the tracking component 630 may be configured as or otherwise support a means for sending to the memory system, based on sending the plurality of access requests, a request to read a plurality of counters stored at the memory system that tracks a quantity of times respective page indices of the plurality of page indices have been accessed during the interval, where the access pattern is generated based on values of the plurality of counters.

In some examples, the tracking component 630 may be configured as or otherwise support a means for sending, prior to sending the plurality of access requests, one or more parameters associated with monitoring the access pattern, the one or more parameters including a page granularity, a page range, a counting interval, a threshold value, a tracking mode, or any combination thereof.

In some examples, a duration of the counting interval is based on a rate at which different page indices of the plurality of page indices map to a same counter of a plurality of counters that tracks a quantity of times respective page indices of the plurality of page indices have been accessed during the interval.

In some examples, the tracking component 630 may be configured as or otherwise support a means for clearing, after reading the contents of the buffer, the buffer.

In some examples, the described functionality of the host system 620, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the host system 620, or various components thereof, may be implemented at least in part by instructions (e.g., stored in memory, non-transitory computer-readable medium) executable by such at least one processor.

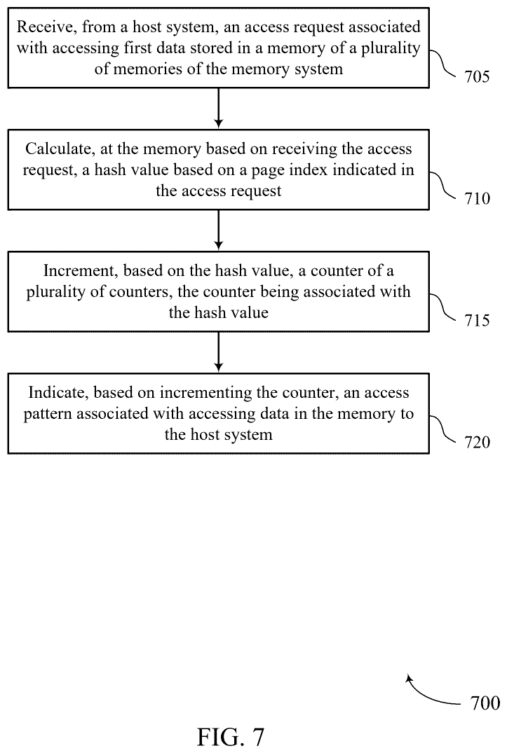

FIG. 7 shows a flowchart illustrating a method 700 that supports access pattern tracking in accordance with examples as disclosed herein. The operations of method 700 may be implemented by a memory system or its components as described herein. For example, the operations of method 700 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 705, the method may include receiving, from a host system, an access request associated with accessing first data stored in a memory of a plurality of memories of the memory system. The operations of 705 may be performed in accordance with examples as disclosed herein. For example, the memory system may include a request processing component 525 that receives, from a host system (e.g., the host system 105 of FIG. 1), an access request associated with accessing first data stored in a memory of a plurality of memories of the memory system—e.g., as described herein, including with reference to the operations described at 309 of FIG. 3.

At 710, the method may include calculating, at the memory based on receiving the access request, a hash value based on a page index indicated in the access request. The operations of 710 may be performed in accordance with examples as disclosed herein. For example, the memory system may include a hash calculation component 530 that calculates, at the memory based on receiving the access request, a hash value based on a page index indicated in the access request—e.g., as described herein, including with reference to the operations described at 316 of FIG. 3.

At 715, the method may include incrementing, based on the hash value, a counter of a plurality of counters, the counter being associated with the hash value. The operations of 715 may be performed in accordance with examples as disclosed herein. For example, the memory system may include a tracking component 535 that increments, based on the hash value, a counter of a plurality of counters, the counter being associated with the hash value e.g., as described herein, including with reference to the operations described at 319 of FIG. 3.

At 720, the method may include indicating, based on incrementing the counter, an access pattern associated with accessing data in the memory to the host system. The operations of 720 may be performed in accordance with examples as disclosed herein. For example, the memory system may include a signaling component 540 that indicates, based on incrementing the counter, an access pattern associated with accessing data in the memory to the host system—e.g., as described herein, including with reference to the operations described at 332 of FIG. 3.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving, from a host system, an access request associated with accessing first data stored in a memory of a plurality of memories of the memory system; calculating, at the memory based on receiving the access request, a hash value based on a page index indicated in the access request; incrementing, based on the hash value, a counter of a plurality of counters, the counter being associated with the hash value; and indicating, based on incrementing the counter, an access pattern associated with accessing data in the memory to the host system.

Aspect 2: The method, apparatus, or non-transitory computer-readable medium of aspect 1, further including operations, features, circuitry, logic, means, or instructions, or any combination thereof for comparing, after incrementing the counter, a value of the counter with a threshold value.

Aspect 3: The method, apparatus, or non-transitory computer-readable medium of any of aspects 1 through 2, further including operations, features, circuitry, logic, means, or instructions, or any combination thereof for storing, based on a value of the counter exceeding a threshold value after incrementing the counter, the page index in a buffer.

Aspect 4: The method, apparatus, or non-transitory computer-readable medium of aspect 3, further including operations, features, circuitry, logic, means, or instructions, or any combination thereof for storing, based on storing the page index in the buffer, an indication that the page index associated with the counter is stored in the buffer.

Aspect 5: The method, apparatus, or non-transitory computer-readable medium of any of aspects 3 through 4, further including operations, features, circuitry, logic, means, or instructions, or any combination thereof for removing, based on storing the page index in the buffer, a second page index from the buffer based on the buffer being full, the second page index being stored in the buffer for a longest duration relative to other page indices stored in the buffer.

Aspect 6: The method, apparatus, or non-transitory computer-readable medium of any of aspects 3 through 5, further including operations, features, circuitry, logic, means, or instructions, or any combination thereof for receiving from the host system, after storing the page index in the buffer, a request to read the buffer, the plurality of counters, or both, where indicating the access pattern to the host system includes outputting, to the host system, contents of the buffer, values of the plurality of counters, or both, in response to the request to read the buffer, the plurality of counters, or both.

Aspect 7: The method, apparatus, or non-transitory computer-readable medium of aspect 6, further including operations, features, circuitry, logic, means, or instructions, or any combination thereof for clearing, based on outputting the contents of the buffer, the values of the plurality of counters, or both, to the host system, the buffer and the plurality of counters.

Aspect 8: The method, apparatus, or non-transitory computer-readable medium of aspect 6, further including operations, features, circuitry, logic, means, or instructions, or any combination thereof for clearing, based on an expiration of a counting interval associated with monitoring access requests, the buffer and the plurality of counters.

Aspect 9: The method, apparatus, or non-transitory computer-readable medium of any of aspects 1 through 7, further including operations, features, circuitry, logic, means, or instructions, or any combination thereof for receiving from the host system, prior to receiving the access request, one or more parameters associated with monitoring the access pattern, the one or more parameters including a page granularity, a page range, a counting interval, a threshold value, a tracking mode, or any combination thereof and configuring data to be stored in the memory based on the page granularity, the plurality of counters based on the page range and the page granularity, a value for updating values of the plurality of counters based on the counting interval, a value to be compared with updated values of the plurality of counters based on the threshold value, a mode for tracking read accesses, write accesses, or both, based on the tracking mode, or any combination thereof.

Aspect 10: The method, apparatus, or non-transitory computer-readable medium of aspect 9, further including operations, features, circuitry, logic, means, or instructions, or any combination thereof for receiving, after the configuring, a command from the host system to monitor access requests, wherein the access request is received after the command.

Aspect 11: The method, apparatus, or non-transitory computer-readable medium of any of aspects 1 through 9, further including operations, features, circuitry, logic, means, or instructions, or any combination thereof for setting, prior to receiving the access request, a sampling rate associated with monitoring the access pattern; receiving, based on setting the sampling rate, a plurality of access requests during a counting interval, the plurality of access requests including the access request; and processing, based on receiving the plurality of access requests, a subset of a plurality of page indices received in the plurality of access requests based on the sampling rate, where the hash value for the page index indicated in the access request is calculated based on the page index being included in the subset of the plurality of page indices.

Aspect 12: The method, apparatus, or non-transitory computer-readable medium of any of aspects 1 through 11, further including operations, features, circuitry, logic, means, or instructions, or any combination thereof for receiving, prior to receiving the access request, an indication of a page range for which the access pattern is to be monitored, where a quantity of the plurality of counters is based on the page range.

Aspect 13: The method, apparatus, or non-transitory computer-readable medium of any of aspects 1 through 12, where the memory includes a plurality of memory devices coupled with a controller of the memory.

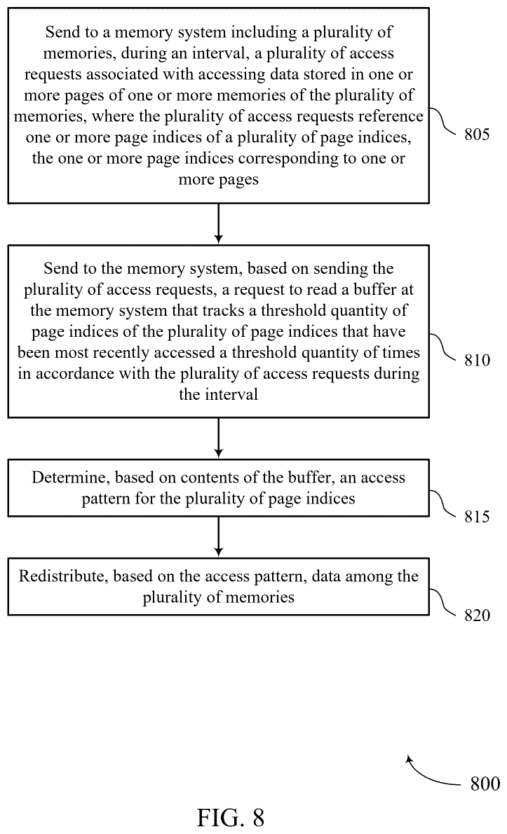

FIG. 8 shows a flowchart illustrating a method 800 that supports access pattern tracking in accordance with examples as disclosed herein. The operations of method 800 may be implemented by a host system or its components as described herein. For example, the operations of method 800 may be performed by a host system as described with reference to FIGS. 1 through 4 and 6. In some examples, a host system may execute a set of instructions to control the functional elements of the device to perform the described functions. Additionally, or alternatively, the host system may perform aspects of the described functions using special-purpose hardware.

At 805, the method may include sending to a memory system including a plurality of memories, during an interval, a plurality of access requests associated with accessing data stored in one or more pages of one or more memories of the plurality of memories, where the plurality of access requests reference one or more page indices of a plurality of page indices, the one or more page indices corresponding to one or more pages. The operations of 805 may be performed in accordance with examples as disclosed herein. For example, the host system may include an access request component 625 that sends to a memory system (e.g., the memory system 110 of FIG. 1) including a plurality of memories, during an interval, a plurality of access requests associated with accessing data stored in one or more pages of one or more memories of the plurality of memories, where the plurality of access requests reference one or more page indices of a plurality of page indices, the one or more page indices corresponding to one or more pages—e.g., as described herein, including with reference to the operations described at 309 of FIG. 3.

At 810, the method may include sending to the memory system, based on sending the plurality of access requests, a request to read a buffer at the memory system that tracks a threshold quantity of page indices of the plurality of page indices that have been most recently accessed a threshold quantity of times in accordance with the plurality of access requests during the interval. The operations of 810 may be performed in accordance with examples as disclosed herein. The operations of 805 may be performed in accordance with examples as disclosed herein. For example, the host system may include a tracking component 630 that sends to the memory system, based on sending the plurality of access requests, a request to read a buffer at the memory system that tracks a threshold quantity of page indices of the plurality of page indices that have been most recently accessed a threshold quantity of times in accordance with the plurality of access requests during the interval—e.g., as described herein, including with reference to the operations described at 329 of FIG. 3.

At 815, the method may include determining, based on contents of the buffer, an access pattern for the plurality of page indices. The operations of 815 may be performed in accordance with examples as disclosed herein. The operations of 805 may be performed in accordance with examples as disclosed herein. For example, the host system may include an access pattern component 635 that determines, based on contents of the buffer, an access pattern for the plurality of page indices—e.g., as described herein, including with reference to the operations described at 342 of FIG. 3.

At 820, the method may include redistributing, based on the access pattern, data among the plurality of memories. The operations of 820 may be performed in accordance with examples as disclosed herein. The operations of 805 may be performed in accordance with examples as disclosed herein. For example, the host system may include a data management component 640 that redistributes, based on the access pattern, data among the plurality of memories—e.g., as described herein, including with reference to the operations described at 346 of FIG. 3.

In some examples, an apparatus as described herein may perform a method or methods, such as the method 800. The apparatus may include features, circuitry, logic, means, or instructions (e.g., a non-transitory computer-readable medium storing instructions executable by a processor), or any combination thereof for performing the following aspects of the present disclosure:

Aspect 14: A method, apparatus, or non-transitory computer-readable medium including operations, features, circuitry, logic, means, or instructions, or any combination thereof for sending to a memory system including a plurality of memories, during an interval, a plurality of access requests associated with accessing data stored in one or more pages of one or more memories of the plurality of memories, where the plurality of access requests reference one or more page indices of a plurality of page indices, the one or more page indices corresponding to one or more pages; sending to the memory system, based on sending the plurality of access requests, a request to read a buffer at the memory system that tracks a threshold quantity of page indices of the plurality of page indices that have been most recently accessed a threshold quantity of times in accordance with the plurality of access requests during the interval; determining, based on contents of the buffer, an access pattern for the plurality of page indices; and redistributing, based on the access pattern, data among the plurality of memories.

Aspect 15: The method, apparatus, or non-transitory computer-readable medium of aspect 14, further including operations, features, circuitry, logic, means, or instructions, or any combination thereof for sending to the memory system, based on sending the plurality of access requests, a request to read a plurality of counters stored at the memory system that tracks a quantity of times respective page indices of the plurality of page indices have been accessed during the interval, where the access pattern is generated based on values of the plurality of counters.

Aspect 16: The method, apparatus, or non-transitory computer-readable medium of any of aspects 14 through 15, further including operations, features, circuitry, logic, means, or instructions, or any combination thereof for sending, prior to sending the plurality of access requests, one or more parameters associated with monitoring the access pattern, the one or more parameters including a page granularity, a page range, a counting interval, a threshold value, a tracking mode, or any combination thereof.

Aspect 17: The method, apparatus, or non-transitory computer-readable medium of aspect 16, where a duration of the counting interval is based on a rate at which different page indices of the plurality of page indices map to a same counter of a plurality of counters that tracks a quantity of times respective page indices of the plurality of page indices have been accessed during the interval.

Aspect 18: The method, apparatus, or non-transitory computer-readable medium of any of aspects 14 through 17, further including operations, features, circuitry, logic, means, or instructions, or any combination thereof for clearing, after reading the contents of the buffer, the buffer.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method at a memory system, comprising:
receiving, from a host system, an access request associated with accessing first data stored in a memory of a plurality of memories of the memory system;
calculating, at the memory based on receiving the access request, a hash value based on a page index indicated in the access request;
incrementing, based on the hash value, a counter of a plurality of counters, the counter being associated with the hash value; and
indicating, based on incrementing the counter, an access pattern associated with accessing data in the memory to the host system.

2. The method of claim 1, further comprising:
comparing, after incrementing the counter, a value of the counter with a threshold value.

3. The method of claim 1, further comprising:
storing, based on a value of the counter exceeding a threshold value after incrementing the counter, the page index in a buffer.

4. The method of claim 3, further comprising:
storing, based on storing the page index in the buffer, an indication that the page index associated with the counter is stored in the buffer.

5. The method of claim 3, further comprising:
removing, based on storing the page index in the buffer, a second page index from the buffer based on the buffer being full, the second page index being stored in the buffer for a longest duration relative to other page indices stored in the buffer.

6. The method of claim 3, further comprising:
receiving from the host system, after storing the page index in the buffer, a request to read the buffer, the plurality of counters, or both;
wherein indicating the access pattern to the host system comprises outputting, to the host system, contents of the buffer, values of the plurality of counters, or both, in response to the request to read the buffer, the plurality of counters, or both.

7. The method of claim 6, further comprising:
clearing, based on outputting the contents of the buffer, the values of the plurality of counters, or both, to the host system, the buffer and the plurality of counters.

8. The method of claim 6, further comprising:
clearing, based on an expiration of a counting interval associated with monitoring access requests, the buffer and the plurality of counters.

9. The method of claim 1, further comprising:
receiving from the host system, prior to receiving the access request, one or more parameters associated with monitoring the access pattern, the one or more parameters comprising a page granularity, a page range, a counting interval, a threshold value, a tracking mode, or any combination thereof; and
configuring data to be stored in the memory based on the page granularity, the plurality of counters based on the page range and the page granularity, a value for updating values of the plurality of counters based on the counting interval, a value to be compared with updated values of the plurality of counters based on the threshold value, a mode for tracking read accesses, write accesses, or both, based on the tracking mode, or any combination thereof.

10. The method of claim 9, further comprising:
receiving, after the configuring, a command from the host system to monitor access requests, wherein the access request is received after the command.

11. The method of claim 1, further comprising:
setting, prior to receiving the access request, a sampling rate associated with monitoring the access pattern;
receiving, based on setting the sampling rate, a plurality of access requests during a counting interval, the plurality of access requests comprising the access request; and
processing, based on receiving the plurality of access requests, a subset of a plurality of page indices received in the plurality of access requests based on the sampling rate, wherein the hash value for the page index indicated in the access request is calculated based on the page index being included in the subset of the plurality of page indices.

12. The method of claim 1, further comprising:
receiving, prior to receiving the access request, an indication of a page range for which the access pattern is to be monitored, wherein a quantity of the plurality of counters is based on the page range.

13. The method of claim 1, wherein the memory comprises a plurality of memory devices coupled with a controller of the memory.

14. A method at a host system, comprising:
sending to a memory system comprising a plurality of memories, during an interval, a plurality of access requests associated with accessing data stored in one or more pages of one or more memories of the plurality of memories, wherein the plurality of access requests reference one or more page indices of a plurality of page indices, the one or more page indices corresponding to one or more pages;
sending to the memory system, based on sending the plurality of access requests, a request to read a buffer at the memory system that tracks a threshold quantity of page indices of the plurality of page indices that have been most recently accessed a threshold quantity of times in accordance with the plurality of access requests during the interval;
determining, based on contents of the buffer, an access pattern for the plurality of page indices; and
redistributing, based on the access pattern, data among the plurality of memories.

15. The method of claim 14, further comprising:
sending to the memory system, based on sending the plurality of access requests, a request to read a plurality of counters stored at the memory system that tracks a quantity of times respective page indices of the plurality of page indices have been accessed during the interval, wherein the access pattern is generated based on values of the plurality of counters.

16. The method of claim 14, further comprising:
sending, prior to sending the plurality of access requests, one or more parameters associated with monitoring the access pattern, the one or more parameters comprising a page granularity, a page range, a counting interval, a threshold value, a tracking mode, or any combination thereof.

17. The method of claim 16, wherein a duration of the counting interval is based on a rate at which different page indices of the plurality of page indices map to a same counter of a plurality of counters that tracks a quantity of times respective page indices of the plurality of page indices have been accessed during the interval.

18. The method of claim 14, further comprising:
clearing, after reading the contents of the buffer, the buffer.

19. A memory system, comprising:
one or more memory devices; and
processing circuitry coupled with the one or more memory devices and configured to cause the memory system to:
receive, from a host system, an access request associated with accessing first data stored in a memory device of the one or more memory devices;
calculate, at the memory system based on receiving the access request, a hash value based on a page index indicated in the access request;
increment, based on the hash value, a counter of a plurality of counters, the counter being associated with the hash value; and
indicate, based on incrementing the counter, an access pattern associated with accessing data in the memory system to the host system.

20. The memory system of claim 19, wherein the processing circuitry is further configured to cause the memory system to:
compare after incrementing the counter, a value of the counter with a threshold value.

21. The memory system of claim 19, wherein the processing circuitry is further configured to cause the memory system to:
store, based on a value of the counter exceeding a threshold value after incrementing the counter, the page index in a buffer.

22. The memory system of claim 19, wherein the processing circuitry is further configured to cause the memory system to:
receive from the host system, prior to receiving the access request, one or more parameters associated with monitoring the access pattern, the one or more parameters comprising a page granularity, a page range, a counting interval, a threshold value, a tracking mode, or any combination thereof; and
configure data to be stored in the memory system based on the page granularity, the plurality of counters based on the page range and the page granularity, a value for updating values of the plurality of counters based on the counting interval, a value to be compared with updated values of the plurality of counters based on the threshold value, a mode for tracking read accesses, write accesses, or both, based on the tracking mode, or any combination thereof.

23. The memory system of claim 19, wherein the processing circuitry is further configured to cause the memory system to:
set, prior to receiving the access request, a sampling rate associated with monitoring the access pattern;
receive, based on setting the sampling rate, a plurality of access requests during a counting interval, the plurality of access requests comprising the access request; and
process, based on receiving the plurality of access requests, a subset of a plurality of page indices received in the plurality of access requests based on the sampling rate, wherein the hash value for the page index indicated in the access request is calculated based on the page index being included in the subset of the plurality of page indices.

24. The memory system of claim 19, wherein the processing circuitry is further configured to cause the memory system to:
receive, prior to receiving the access request, an indication of a page range for which the access pattern is to be monitored, wherein a quantity of the plurality of counters is based on the page range.

25. A host system, comprising:
one or more interfaces comprising one or more signal paths operable for communications with one or more memory systems; and
processing circuitry coupled with the one or more interfaces and configured to cause the host system to:
send to a memory system comprising a plurality of memories, during an interval, a plurality of access requests associated with accessing data stored in one or more pages of one or more memories of the plurality of memories, wherein the plurality of access requests reference one or more page indices of a plurality of page indices, the one or more page indices corresponding to one or more pages;
send to the memory system, based on sending the plurality of access requests, a request to read a buffer at the memory system that tracks a threshold quantity of page indices of the plurality of page indices that have been most recently accessed a threshold quantity of times in accordance with the plurality of access requests during the interval;
determine, based on contents of the buffer, an access pattern for the plurality of page indices; and
redistribute, based on the access pattern, data among the plurality of memories.

26. The host system of claim 25, wherein the processing circuitry is further configured to cause the host system to:
send to the memory system, based on sending the plurality of access requests, a request to read a plurality of counters stored at the memory system that tracks a quantity of times respective page indices of the plurality of page indices have been accessed during the interval, wherein the access pattern is generated based on values of the plurality of counters.

27. The host system of claim 25, wherein the processing circuitry is further configured to cause the host system to:
send, prior to sending the plurality of access requests, one or more parameters associated with monitoring the access pattern, the one or more parameters comprising a page granularity, a page range, a counting interval, a threshold value, a tracking mode, or any combination thereof.

28. The host system of claim 25, wherein the processing circuitry is further configured to cause the host system to:
clear, after reading the contents of the buffer, the buffer.

29. A non-transitory, computer-readable medium storing code comprising instructions executable by processing circuitry coupled with a memory system comprising one or more memory devices to cause the memory system to:
receive, from a host system, an access request associated with accessing first data stored in a memory device of the one or more memory devices;
calculate, at the memory system based on receiving the access request, a hash value based on a page index indicated in the access request;
increment, based on the hash value, a counter of a plurality of counters, the counter being associated with the hash value; and
indicate, based on incrementing the counter, an access pattern associated with accessing data in the memory system to the host system.

30. The non-transitory, computer-readable medium of claim 29, wherein the processing circuitry is further configured to cause the memory system to:
compare after incrementing the counter, a value of the counter with a threshold value.
